(19) United States
(12) Patent Application Publication
(10) Pub. No.: US 2005/0057363 A1
(43) Pub. Date: Mar. 17, 2005

(54) Weather dial

(76) Inventor: Cicero De Oliveira Salles JR., Rockville, MD (US)

Correspondence Address: CICERO DE OLIVEIRA SALLES, JR, 876 IVY LEAGUE LANE, ROCKVILLE, MD, 20850, US

(21) Appl. No.: 10/662,232

(22) Filed: Sep. 15, 2003

(51) Int. Cl. G01W 1/00

(52) U.S. Cl. 340/601

(57) ABSTRACT

The “Weather Dial” graph was developed to illustrate in a clear and concise manner the actual and/or forecast daily meteorological and weather variations. Several weather and meteorological symbols and information, including sunrise and sunset times, morning, afternoon, evening and night weather conditions, high and low temperatures, wind conditions and lunar phases, are succinctly organized in a dial format representing the 24 hours in a day.

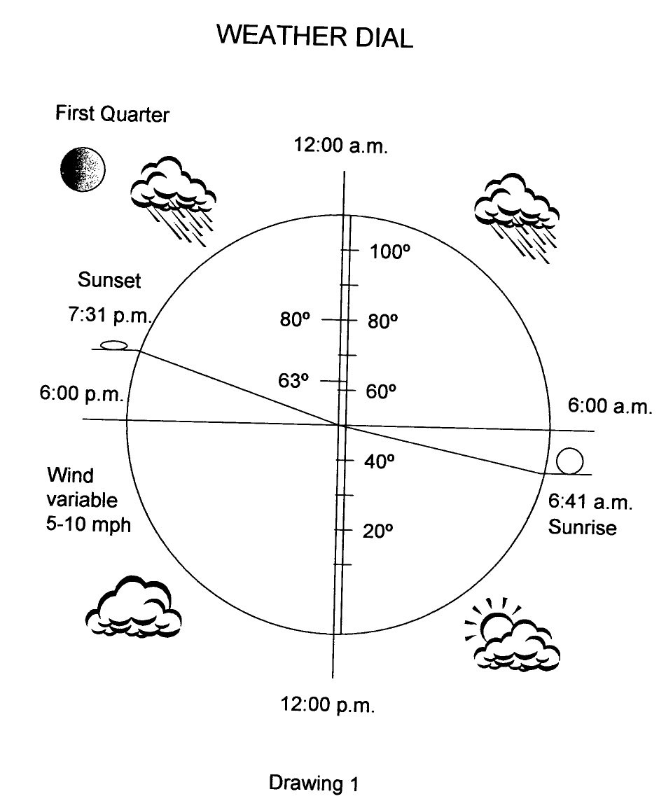

### CROSS-REFERENCE TO RELATED APPLICATIONS

The “Weather Dial” is basically the “Salles 24-Hour Weather Graph” which was also developed by the applicant, Cicero de Oliveira Salles Jr.

The applicant filed for Copyright protection of the Salles Weather Graph and obtained a Certificate of Registration with an Aug. 30, 2002 Effective Date of Registration. The Examiner from the United States Copyright Office, Mr. Ivan Proctor informed that the Copyright Office would not protect the idea and concept of the material, as desired by the applicant, but rather, would only protect “the original work of art”. Therefore the applicant seeks to protect the original idea and concept of the Weather Dial by obtaining a patent from the United States Patent and Trademark Office.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Advances in meteorological and weather forecasting have enabled forecasters to better predict weather conditions and variations during the day. However, the displays and portrayals of the daily weather variations produced to date have been limited in information and not very concise. Therefore the “Weather Dial” was created to display in a clear and concise manner daily meteorological and weather variations.

### BRIEF SUMMARY OF THE INVENTION

The “Weather Dial” graph is an easy and clear way to display and integrate information regarding the daily weather variations (actual or forecasts) and meteorological conditions.

### BRIEF DESCRIPTION OF THE SEVERAL VIEWS OF THE DRAWING

Drawing 1: Weather Dial

### DETAILED DESCRIPTION OF THE INVENTION

The “Weather Dial” can be useful to different media types such as newspapers, television stations, Internet sites and magazines in the presentation of weather and meteorological information to their public, because the weather and meteorological daily variations are displayed in a concise, clear, and succinct manner. Information presented in the “Weather Dial” graph includes, but would not be limited to:
Sunrise and sunset times
Morning, afternoon, evening and night weather conditions
Daily temperatures
Wind Conditions
Lunar phases

The weather dial is to be used either clockwise or counter-clockwise, where one complete revolution (360°) is equal to one day (24 hours). The attached drawings show 6-hour intervals, where each quadrant is clearly labeled 12:00 a.m., 6:00 a.m., 12:00 p.m. and 6:00 p.m. (standard US time). Symbols representing the weather conditions (rain, sun, thunderstorms, partially overcast, snow etc . . . ) are shown in each of the quadrants representing 6-hours (or other divisions of time). The area of the graph between sunset and sunrise can be shaded to indicate nighttime, clearly showing shorter days during winter months and longer days during summer months. Additionally, snow accumulation (number of inches) can also be shown on the graph.

The actual and forecast high and low temperatures can be shown on the drawing axis (as shown in the attached drawing), or any other appropriate location in the drawing.

1. What I claim as my invention is the portrayal of daily variations of weather and meteorological conditions illustrated in a dial format, used to represent one day.
